(19) United States
(12) Patent Application Publication
(10) Pub. No.: US 2014/0311582 A1
(43) Pub. Date: Oct. 23, 2014

(54) Thermally Regulated Fluid Transport System and Methods Thereof

(71) Applicant: DEKORON UNITHERM INC., CAPE CORAL, FL (US)

(72) Inventors: Jerry Bunch, JR., Fort Myers, FL (US); James Stahl, Cape Coral, FL (US); James Bradley, Pt. Charlotte, FL (US); Erik Langdon, Cape Coral, FL (US)

(21) Appl. No.: 14/243,227

(22) Filed: Apr. 2, 2014

Related U.S. Application Data
(60) Provisional application No. 61/807,449, filed on Apr. 2, 2013.

(51) Int. Cl. F16L 53/00; F16L 59/14

(52) U.S. Cl. CPC F16L 53/001; F16L 59/14
USPC 137/15.01; 137/334

(57) ABSTRACT

A fluid transport system and related methods is disclosed. The fluid transport system includes an elongated conduit having at least one fluid-transporting pathway. At least one heat tracing structure is bonded to a surface of the elongated conduit. A thermal conductor is removably positioned within the at least one heat tracing structure, wherein a quantity of thermal energy is transferred from the thermal conductor to the at least one fluid-transporting pathway. A bundle jacket is positioned about the exterior of the elongated conduit and the at least one heat tracing structure.

### CROSS REFERENCE TO RELATED APPLICATION

This application claims benefit of U.S. Provisional Application Ser. No. 61/807,449 entitled, “Thermally regulated fluid transport system and methods thereof” filed Apr. 2, 2013, the entire disclosure of which is incorporated herein by reference.

### FIELD OF THE DISCLOSURE

The present disclosure is generally related to fluid transport systems and more particularly is related to thermally regulated fluid transport systems and methods thereof.

### BACKGROUND OF THE DISCLOSURE

Conduits are used within many industries and for many different purposes. For example, in some industries conduits are used for fluid or gas transport, and it is often necessary to retain the fluid or gas within the conduit at a specific temperature. In colder climates, such as in harsh artic climates, devices are used to keep fluid-transporting conduits above the freezing point of the fluid transported therein. One conventional way to heat the conduit is to place one or more heat cables within the conduit structure and proximate to the pipes or tubes that transport the fluid. These conventional heat cables are connected to a power source and generate heat which is conducted to the fluid transporting tubes within the conduit. Another way to heat the conduits is to apply an external heat jacket about the conduit.

While the use of conventional heated cables provides some benefits, it also has many shortcomings. External heated jackets are timely to install and heat from the outside in, such that a significant portion of the thermal energy is lost to the ambient air. When conventional internally heated conduits are used, a connector must be utilized to connect the heat cable of one conduit with the heat cable of another conduit. When conduits are sold in lengths of twenty feet, many connectors may be needed for certain industries requiring extended lengths of conduits. Each of the connectors may require the use of a splicing kit which is expensive, especially with long conduit paths. These connectors are difficult and timely to install between conduits, especially in climates that are not conducive to exposing works to harsh weather conditions.

Furthermore, the use of a connector between the conduit lengths leaves the conduits susceptible to damage from the environment, such as from water exposure, and prone to malfunction, since the conduit joint having the connector is often not as strong or durable as the conduit itself. Another limitation of conventional heating cables is that they are substantially permanent within the conduit. If the heating cable breaks or requires removal or replacement, it is highly difficult to remove it from the conduit without damaging the conduit, and it is virtually impossible to replace a damaged heating cable from a conduit with a new heating cable.

Thus, a heretofore unaddressed need exists in the industry to address the aforementioned deficiencies and inadequacies.

### SUMMARY OF THE DISCLOSURE

Embodiments of the present disclosure provide a fluid transport system and related methods. Briefly described, in architecture, one embodiment of the system, among others, can be implemented as follows. An elongated conduit has at least one fluid-transporting pathway. At least one heat tracing structure is bonded to a surface of the elongated conduit. A thermal conductor is removably positioned within the at least one heat tracing structure, wherein a quantity of thermal energy is transferred from the thermal conductor to the at least one fluid-transporting pathway. A bundle jacket is positioned about the exterior of the elongated conduit and the at least one heat tracing structure.

The present disclosure can also be viewed as providing methods of installing a thermally-regulated conduit-based fluid transport system. In this regard, one embodiment of such a method, among others, can be broadly summarized by the following steps: providing a plurality of elongated conduits, each having at least one fluid-transporting pathway, wherein at least one heat tracing structure is bonded to a surface of each of the elongated conduits; linearly connecting at least a portion of the plurality of elongated conduits end to end and the at least one heat tracing structure for each of the elongated conduits end to end; and positioning a thermal conductor through the at least one heat tracing structure bonded to each of the connected elongated conduits after linearly connecting the portion of the plurality of elongated conduits, wherein a quantity of thermal energy is transferred from the thermal conductor to the at least one fluid-transporting pathway of each of the linearly connected elongated conduits.

The present disclosure can also be viewed as providing methods of manufacturing a thermally-regulated fluid transport system. In this regard, one embodiment of such a method, among others, can be broadly summarized by the following steps: providing a plurality of elongated conduits, each having at least one fluid-transporting pathway; bonding at least one heat tracing structure to a surface of each of the elongated conduits; linearly connecting at least a portion of the plurality of elongated conduits; positioning a bundle jacket about the exterior of the portion of the elongated conduits having the at least one heat tracing structure bonded thereto; and positioning a thermal conductor through the at least one heat tracing structure bonded to each of the connected elongated conduits after linearly connecting the portion of the plurality of elongated conduits.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional illustration of a fluid transport system, in accordance with a first exemplary embodiment of the present disclosure.

FIG. 2 is a cross-sectional illustration of a fluid transport system, in accordance with a second exemplary embodiment of the present disclosure.

FIG. 3 is a cross-sectional illustration of a fluid transport system, in accordance with a third exemplary embodiment of the present disclosure.

FIG. 4 is a cross-sectional illustration of a fluid transport system, in accordance with a fourth exemplary embodiment of the present disclosure.

FIG. 5 is a cross-sectional illustration of a fluid transport system, in accordance with a fifth exemplary embodiment of the present disclosure.

FIG. 6 is a flowchart illustrating a method of installing a thermally-regulated conduit-based fluid transport system, in accordance with a sixth exemplary embodiment of the disclosure.

FIG. 7 is a flowchart illustrating a method of manufacturing a thermally-regulated fluid transport system, in accordance with a seventh exemplary embodiment of the disclosure.

### DETAILED DESCRIPTION

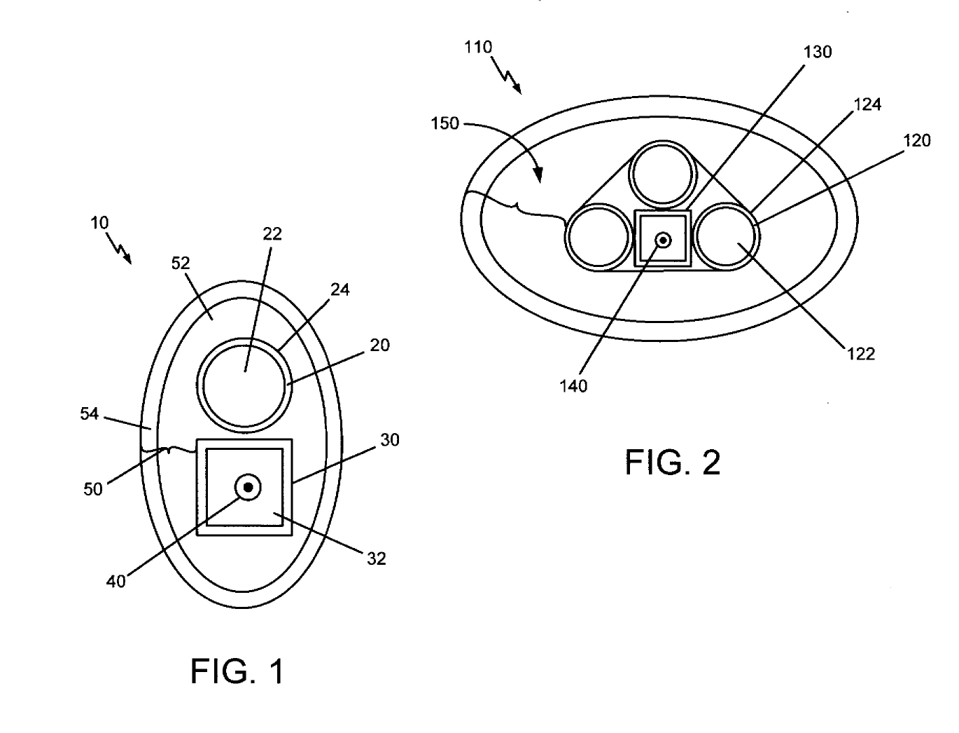

FIG. 1 is a cross-sectional illustration of a fluid transport system 10, in accordance with a first exemplary embodiment of the present disclosure. The fluid transport system 10, which may be referred to simply as ‘system 10’ includes an elongated conduit 20 having at least one fluid-transporting pathway 22. At least one heat tracing structure 30 is bonded to a surface 24 of the elongated conduit 20. A thermal conductor 40 is removably positioned within the at least one heat tracing structure 30, wherein a quantity of thermal energy is transferred from the thermal conductor 40 to the at least one fluid-transporting pathway 22. A bundle jacket 50 is positioned about the exterior of the elongated conduit 20 and the at least one heat tracing structure 30.

The system 10 may be used within a variety of industries and settings, including any setting having the need for fluid transportation through conduits or temperature-controlled or temperature-regulated conduits. The system 10 may be formed with a variety of industry-specific materials, such as materials used to enhance the usability, durability, or maintenance of the system 10. The system 10 may also be formed at any size length, diameter, or width, as may be determined on the intended use of the system 10.

The system 10 includes at least one elongated conduit 20 having at least one fluid-transporting pathway 22 that is sized to hold, carry, and transport any type of fluid or gas. For example, the elongated conduit 20 having the fluid-transporting pathway 22 may include any type of fluid-transporting pipe, conduit, hose, or similar structure. Any number of elongated conduits 20 may be included with the system 10, and they may be constructed at any size and out of any type of material. Bonded to the exterior surface 24 of the elongated conduit 20 is at least one heat tracing structure 30, having an open interior portion through which a thermal conductor 40 can be placed within. The heat tracing structure 30 may be bonded along the axial length of the elongated conduit 20, wherein the heat tracing structure 30 may contact the entire length of the elongated conduit 20. The heat tracing structure 30 may be bonded with a chemical bond using an adhesive or similar material, using a mechanical attachment such as welding, or by being integrally formed to the elongated conduit 20, such as through an extrusion process. Accordingly, to ensure proper heat transfer between the heat tracing structure 30 and the elongated conduit 20, the heat tracing structure 30 is to be bonded to at least part of the exterior surface of the elongated conduit 20, thereby positioned directly contacting the surface of the elongated conduit 20.

A material used for the elongated conduit 20 must be capable of operating successfully under the pressure, temperature, and chemical conditions of the fluid being processed within the pathway 22. The heat tracing structure 30 is constructed from a material having excellent thermal conductivity, such that the heat produced or carried within the thermal conductor 40 is able to be thermally transmitted through the heat tracing structure 30 and to the elongated conduit 20. The material of the heat tracing structure 30 may be a material that is close to the elongated conduit in the galvanic series. Improper selection of the materials for the elongated conduit 20 and/or the heat tracing structure 30 may lead to corrosion or one or both structures, which may cause operating failures in the elongated conduit 20, and/or complications with heat transfer through the heat tracing structure 30, which may lead to failures of the overall system 10. The elongated conduit 20, heat tracing structure 30, and the system 10 as a whole may all be airtight, water-tight, and capable of being pressurized.

As is shown in FIG. 1, the heat tracing structure 30 includes an interior portion 32 that is substantially hollow, thereby allowing the thermal conductor 40 to be positioned therein. It is noted that the heat tracing structure 30 may be formed with a variety of cross-sectional shapes and sized according to the use of the system 10. The thermal conductor 40 may be removably positioned within the heat tracing structure 30, such that it can be inserted, removed, or otherwise manipulated within the heat tracing structure 30. The thermal conductor 40 may include a variety of different types of thermal materials, including a heat-producing electrical wire, a thermal material activated with catalysts, and a fluid thermal conductor, such as heated oil, among others.

While the thermal conductor 40 may be inserted into the heat tracing structure 30 during any point of manufacturing and/or installation, it may be preferable for the thermal conductor 40 to be positioned within the heat tracing structure 30 after a plurality of elongated conduits 20 have been linearly connected together. For example, a plurality of elongated conduits 20 may be connected together and the bundle jacket 50 may be positioned about both the elongated conduits 20 and the heat tracing structures 30. Then, the thermal conductor 40 may be fed into the heat tracing structures 30 from one end of one elongated conduit 20 to one end of another elongated conduit 20.

The flexibility in inserting and removing the thermal conductor 40 at a user's convenience may allow for easier and more convenient insertion of the thermal conductor 40 after installation of the system 10. Additionally, this ability may allow for removal of the thermal conductor 40 from the heat tracing structures 30 when it needs to be repaired, replaced, or otherwise accessed. For example, the thermal conductor 40 may be installed and removed within a plurality of elongated conduits 20 without the need for splicing kits or connectors facilitating the thermal conductor 40 between each elongated conduit 20 segments. Thus, when a plurality of elongated conduits 20 are connected together, they may be wrapped with the bundle jacketing 50 and installed, and then the thermal conductor 40 may be strung through the heat tracing structures 30. If the thermal conductor 40 is damaged or becomes inoperative, it can be replaced without having to remove the system 10 or remove the bundle jacket 50.

Additionally, the positioning of the thermal conductor 40 within the heat tracing structures 30 may reduce the surface temperature of the thermal conductor 40—especially with an electric heat tracing cable—that comes in contact with the elongated conduit 20. This partial insulating effect may prevent damage to the elongated conduit 20 when using a heater with higher output, which in turn, may allow for a reduction of an amount of insulation required within the bundle jacket 50. The ability to partially insulate the elongated conduit 20 from undesired high temperatures of direct contact with the thermal conductor may be essential when using an elongated conduit 20 that susceptible to degradation from heat, such as a PVC or CPVC pipe.

The thermal conductor 40 may include either a heating element formed therein or a pre-heated material that flows therethrough. For example, the thermal conductor 40 may be an electrical wire having a heating element formed along its length. In another example, the thermal conductor 40 may transport a heated fluid, such as heated oil, through an interior pathway, thereby allowing the heat from the heated fluid to be conducted into the thermal conductor 40 and on to the elongated conduit 20. Other heating means may also be available, as may be recognized by one having skill in the art.

The bundle jacket 50 is positioned about the exterior of the elongated conduit 20 and the at least one heat tracing structure 30, such that it insulates and/or protects both the elongated conduit 20 and the at least one heat tracing structure 30, as well as other components that are positioned interior of the bundle jacket 50. The bundle jacket 50 may include any number of layers of materials, including, for example, an insulation layer 52 and a jacketing layer 54, as is shown in FIG. 1. The jacketing layer 54 may be positioned exterior of the insulation layer 52, such that it protects the insulation layer. The jacketing layer 54 may include a rubberized jacket, an armored jacket formed from a metal or other durable material, or another type of jacketing material. Furthermore, the bundle jacket 50 in some situations may be removable to expose the elongated conduit 20 and the heat tracing structure 30 without causing damage to them.

FIG. 2 is a cross-sectional illustration of a fluid transport system 110, in accordance with a second exemplary embodiment of the present disclosure. The fluid transport system 110, which may be referred to herein as ‘system 110’ is substantially similar to the system 10 of FIG. 1, and may include any of the features, characteristics, or structures described with respect to any embodiment of this disclosure. The system 110 includes a plurality of elongated conduits 120, each having at least one fluid-transporting pathway 122. A heat tracing structure 130 is bonded to a surface 124 of each of the elongated conduits 120. A thermal conductor 140 is removably positioned within the at least one heat tracing structure 130, wherein a quantity of thermal energy is transferred from the thermal conductor 140 to the fluid-transporting pathways 122 for each of the elongated conduits 120. A bundle jacket 150 is positioned about the exterior of all elongated conduits 120 and the heat tracing structure 130.

As is shown in FIG. 2, the system 110 may include any number of elongated conduits 120 positioned about and bonded to one heat tracing structure 130. This configuration may allow for thermal regulation of the system 110 without overly increasing the cross-sectional size of the system 110. The thermal energy provided by the thermal conductor 140 may be sufficient to provide the desired thermal regulation within each of the elongated conduits 120. While the heat tracing structure 130 may be bonded to each of the elongated conduits 120 in a variety of configurations, it may be beneficial for the heat tracing structure 130 to be positioned interior of each of the elongated conduits 120 to allow for more consistent heat transfer to the elongated conduits 120.

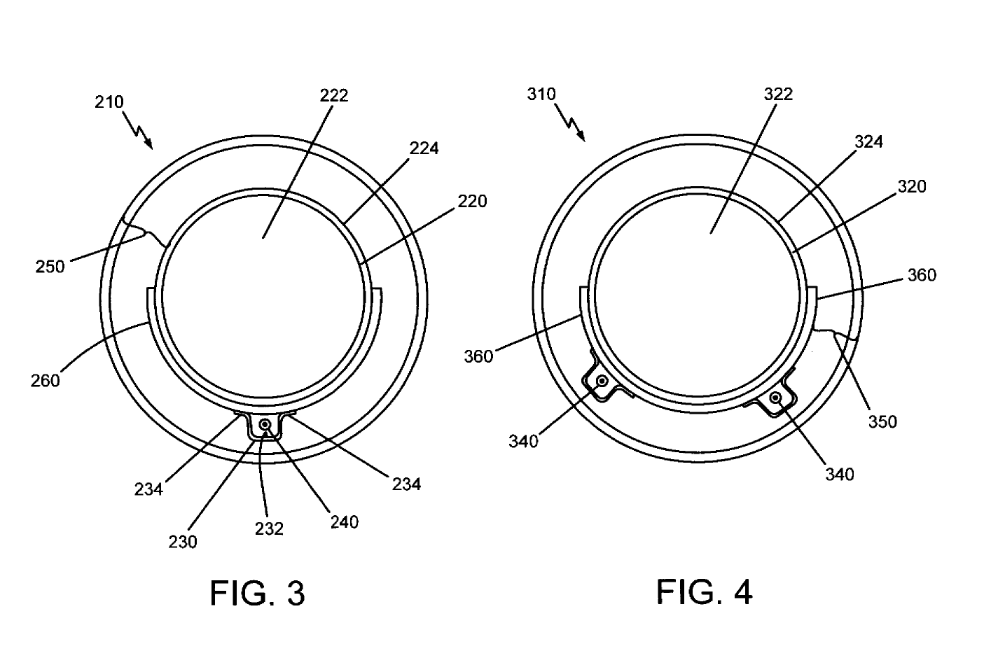

FIG. 3 is a cross-sectional illustration of a fluid transport system 210, in accordance with a third exemplary embodiment of the present disclosure. The fluid transport system 210, which may be referred to herein as ‘system 210’ may be substantially similar to the other systems of this disclosure and may include any of the features, characteristics, or structures described with respect to any embodiment of this disclosure. The system 210 includes an elongated conduit 220, having at least one fluid-transporting pathway 222. A heat transfer plate 260 may be positioned between the elongated conduit 220 and at least one heat tracing structure 230, wherein the at least one heat tracing structure 230 is bonded to the heat transfer plate 260, and wherein the heat transfer plate 260 is bonded to the surface 224 of the elongated conduit 220. A thermal conductor 240 is removably positioned within the at least one heat tracing structure 230, wherein a quantity of thermal energy is transferred from the thermal conductor 240 to the fluid-transporting pathways 222 of the elongated conduit 220. A bundle jacket 250 is positioned about the exterior of the elongated conduit 220 and the heat tracing structure 230.

The heat transfer plate 260 may increase the efficiency of heat transfer from the thermal conductor 240 to the fluid-transporting pathway 222 of the elongated conduit 220. The heat transfer plate 260 may be formed from a material having a high thermal conductivity, such as a copper alloy or another metallic material. The heat transfer plate 260 may be shaped to closely abut the exterior surface 224 of the elongated conduit 220 about any portion thereof. For example, as is shown in FIG. 3, the heat transfer plate 260 may be positioned substantially about 20%, 25%, 35%, 50%, 60%, 75%, and/or 100% of the exterior surface 224 of the elongated conduit 220, as may be dependent on the environment in which the system 210 is used. The contact area between the heat transfer plate 260 and the elongated conduit 220 may be selected based on the desired thermal energy transfer of the system 210.

It is noted that the heat tracing structure 230 may have open channel shapes, such that an open side of the heat tracing structure 230 is directly abutting the heat transfer plate 260. For example, the heat tracing structure 230 may include a U-shaped design with wings that allow for attachment to the heat transfer plate 260. As is shown in FIG. 3, the U-shaped design may include a channel portion 232 with terminating ends 234 extending from each side thereof. The terminating ends 234 may be bent or arched to provide a contact surface with the heat transfer plate 260 (or directly to the elongated conduit 220, as the case may be). Other shapes for the heat tracing structure 230 may also be used, all of which are considered within the scope of the present disclosure.

FIG. 4 is a cross-sectional illustration of a fluid transport system 310, in accordance with a fourth exemplary embodiment of the present disclosure. The fluid transport system 310, which may be referred to herein as ‘system 310’ may be substantially similar to the other systems of this disclosure and may include any of the features, characteristics, or structures described with respect to any embodiment of this disclosure. The system 310 includes an elongated conduit 320, having at least one fluid-transporting pathway 322. A heat transfer plate 360 may be positioned between the elongated conduit 320 and a plurality of heat tracing structures 330, wherein the heat tracing structures 330 are bonded to the heat transfer plate 360, and wherein the heat transfer plate 360 is bonded to the surface 324 of the elongated conduit 320. A plurality of thermal conductors 340 are removably positioned within the heat tracing structures 230, respectively, wherein a quantity of thermal energy is transferred from the thermal conductors 340 to the fluid-transporting pathways 322 of the elongated conduit 320. A bundle jacket 350 is positioned about the exterior of the elongated conduit 320 and the heat tracing structures 330.

The system 310 is substantially similar to the system 210 shown in FIG. 3, with the exception that the system 310 includes a plurality of heat tracing structures 330 carrying a plurality of thermal conductors 340. Using more than one heat tracing structure 330 and thermal conductor 340 allows the system 310 to have increased thermal regulation, which may be necessary for extremely frigid conditions, or for elongated conduits 320 that carry a significant volume of fluid. Any number of heat tracing structures 330 carrying a plurality of thermal conductors 340 may be used with the system 310, as may depend on the intended use of the system 310. When a plurality of heat tracing structures 330 are used, each of heat tracing structures 330 may be positioned spaced from one another axially on the heat transfer plate or directly on the elongated conduit 320.

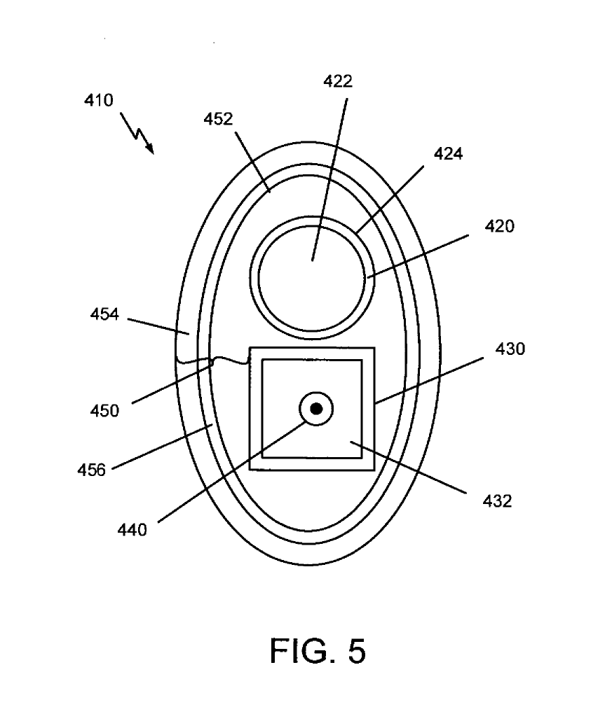

FIG. 5 is a cross-sectional illustration of a fluid transport system 410, in accordance with a fifth exemplary embodiment of the present disclosure. The fluid transport system 410, which may be referred to herein as ‘system 410’ may be substantially similar to the other systems of this disclosure and may include any of the features, characteristics, or structures described with respect to any embodiment of this disclosure. The fluid transport system 410 includes an elongated conduit 420 having at least one fluid-transporting pathway 422. At least one heat tracing structure 430 is bonded to a surface 424 of the elongated conduit 420. A thermal conductor 440 is removably positioned within the at least one heat tracing structure 430, wherein a quantity of thermal energy is transferred from the thermal conductor 440 to the at least one fluid-transporting pathway 422. A bundle jacket 450 is positioned about the exterior of the elongated conduit 420 and the at least one heat tracing structure 430.

The bundle jacket 450 is positioned about the exterior of the elongated conduit 420 and the at least one heat tracing structure 430, such that it insulates and/or protects both the elongated conduit 420 and the at least one heat tracing structure 430, as well as other components that are positioned interior of the bundle jacket 450. The bundle jacket 450 may include any number of layers of materials, including, for example, an insulation layer 452 and a jacketing layer 454, as is shown in FIG. 5. The bundle jacket 450 may also include an aluminum shield 456 positioned between the insulation layer 452 and the jacketing layer 454, which may provide enhanced protection in industries utilizing the system 410 in deep water settings, such as with off-shore drilling systems.

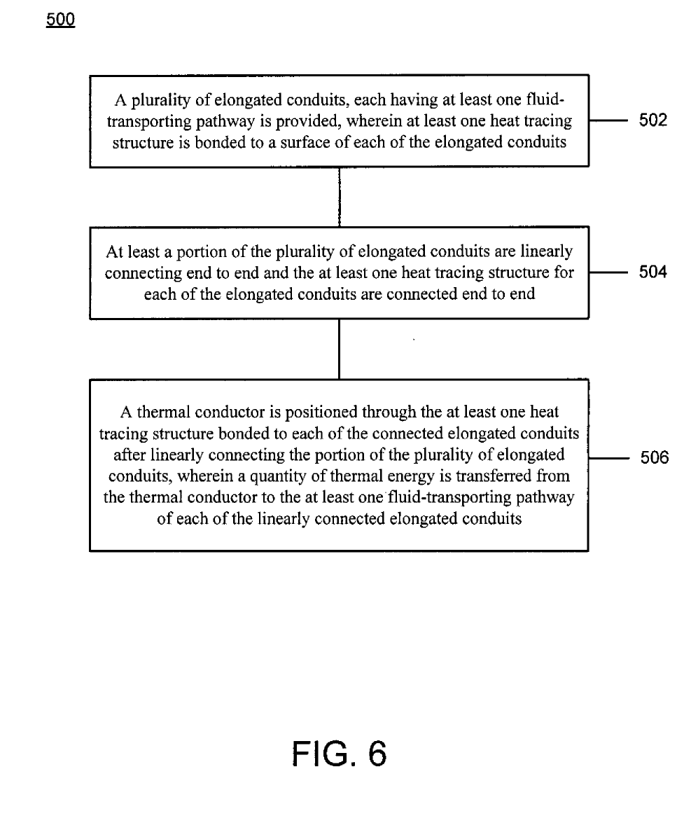

FIG. 6 is a flowchart 500 illustrating a method of installing a thermally-regulated conduit-based fluid transport system, in accordance with a sixth exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 502 a plurality of elongated conduits, each having at least one fluid-transporting pathway is provided, wherein at least one heat tracing structure is bonded to a surface of each of the elongated conduits. At least a portion of the plurality of elongated conduits are linearly connecting end to end and the at least one heat tracing structure for each of the elongated conduits are connected end to end (block 504). A thermal conductor is positioned through the at least one heat tracing structure bonded to each of the connected elongated conduits after linearly connecting the portion of the plurality of elongated conduits, wherein a quantity of thermal energy is transferred from the thermal conductor to the at least one fluid-transporting pathway of each of the linearly connected elongated conduits (block 506).

The method may further include any of the functions, steps, or processes disclosed with respect to FIGS. 1-5 of this disclosure. For example, the method may further include the step of positioning a bundle jacket about each of the exterior of the plurality of elongated conduits and the at least one heat tracing structure, respectively, after positioning the thermal conductor through the at least one heat tracing structure bonded to each of the connected elongated conduits. The heat tracing structure may also partially insulate each of the plurality of elongated conduits from the quantity of thermal energy transferred from the thermal conductor.

Transferring the quantity of thermal energy from the thermal conductor to each of the linearly connected elongated conduits may include the use of a heat transfer plate, wherein the heat transfer plate is bonded between the at least one heat tracing structure and each of the plurality of elongated conduits. The thermal conductor may include a thermal fluid medium which is pumped through the at least one heat tracing structure. If the thermal conductor needs to be replaced, exchanged, or removed, it may be removed from the at least one heat tracing structure without disconnecting the portion of the plurality of elongated conduits end to end and the at least one heat tracing structure for each of the elongated conduits end to end, and a new thermal conductor may be positioned through the at least one heat tracing structure bonded to each of the connected elongated conduits.

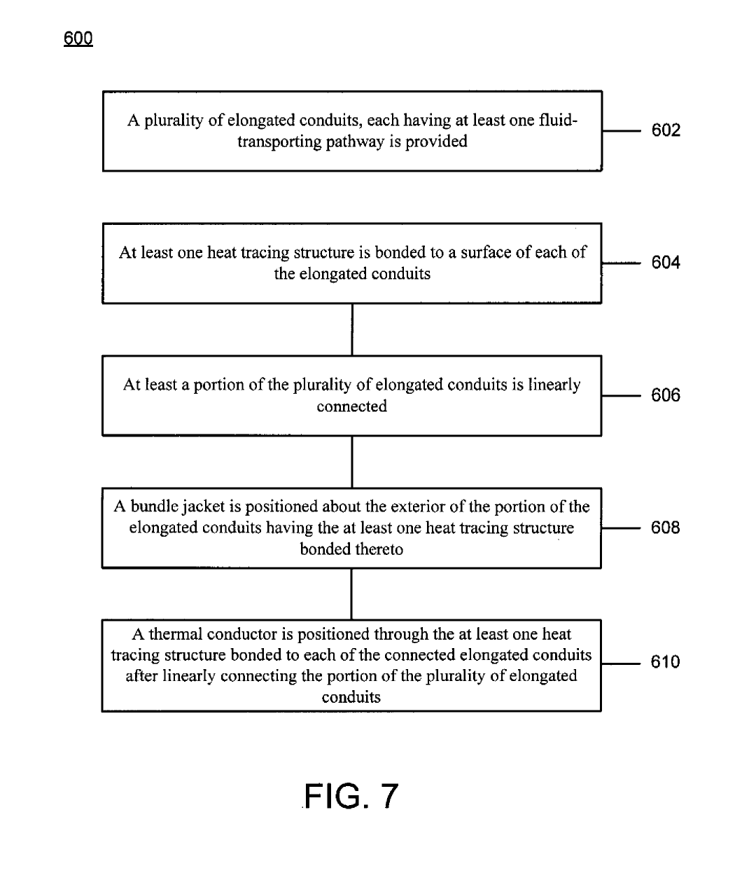

FIG. 7 is a flowchart 600 illustrating a method of manufacturing a thermally-regulated fluid transport system, in accordance with a seventh exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 602 a plurality of elongated conduits, each having at least one fluid-transporting pathway is provided. At least one heat tracing structure is bonded to a surface of each of the elongated conduits (block 604). At least a portion of the plurality of elongated conduits is linearly connected (block 606). A bundle jacket is positioned about the exterior of the portion of the elongated conduits having the at least one heat tracing structure bonded thereto (block 608). A thermal conductor is positioned through the at least one heat tracing structure bonded to each of the connected elongated conduits after linearly connecting the portion of the plurality of elongated conduits (block 610). The method may further include any of the functions, steps, or processes disclosed with respect to FIGS. 1-6 of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A fluid transport system comprising:
an elongated conduit having at least one fluid-transporting pathway;
at least one heat tracing structure bonded to a surface of the elongated conduit;
a thermal conductor removably positioned within the at least one heat tracing structure, wherein a quantity of thermal energy is transferred from the thermal conductor to the at least one fluid-transporting pathway; and
a bundle jacket positioned about the exterior of the elongated conduit and the at least one heat tracing structure.

2. The fluid transport system of claim 1, wherein the bundle jacket further comprises:
an insulation layer; and
at least one jacketing layer, wherein the at least one jacketing layer is positioned exterior of the insulation layer.

3. The fluid transport system of claim 2, wherein the at least one jacking layer further comprises at least one of: an armored jacket; and a rubberized jacket.

4. The fluid transport system of claim 2, further comprising an aluminum shield positioned between the insulation layer and the at least one jacketing layer.

5. The fluid transport system of claim 1, wherein the thermal conductor further comprises a fluid thermal conductor.

6. The fluid transport system of claim 1, wherein the at least one heat tracing structure bonded to the surface of the elongated conduit with a weld.

7. The fluid transport system of claim 1, wherein the elongated conduit and the heat tracing structure are each further constructed from a material selected from a galvanic series.

8. The fluid transport system of claim 1, wherein the elongated conduit further comprises a plurality of elongated conduits, each having at least one fluid-transporting pathway, wherein the at least one heat tracing structure is bonded to an exterior surface of each of the plurality of elongated conduits.

9. The fluid transport system of claim 8, wherein the at least one heat tracing structure is positioned between the plurality of elongated conduits.

10. The fluid transport system of claim 1, further comprising a heat transfer plate positioned between the elongated conduit and the at least one heat tracing structure, wherein the at least one heat tracing structure is bonded to the heat transfer plate, and wherein the heat transfer plate is bonded to the surface of the elongated conduit.

11. The fluid transport system of claim 10, wherein the heat transfer plate is bonded to the surface of the elongated conduit axially about the elongated conduit, wherein the heat transfer plate is positioned axially around at least 25% of the surface of the elongated conduit.

12. The fluid transport system of claim 10, wherein the at least one heat tracing structure further comprises an open channel having a channel portion and at least two terminating ends, wherein the at least two terminating ends are bonded to the heat transfer plate.

13. The fluid transport system of claim 10, wherein the at least one heat tracing structure further comprises at least two heat tracing structures, wherein each of the at least two heat tracing structures are bonded to the heat transfer plate, wherein each of the at least two heat tracing structures are spaced from one another axially on the heat transfer plate.

14. A method of installing a thermally-regulated conduit-based fluid transport system, the method comprising the steps of:
providing a plurality of elongated conduits, each having at least one fluid-transporting pathway, wherein at least one heat tracing structure is bonded to a surface of each of the elongated conduits;
linearly connecting at least a portion of the plurality of elongated conduits end to end and the at least one heat tracing structure for each of the elongated conduits end to end; and
positioning a thermal conductor through the at least one heat tracing structure bonded to each of the connected elongated conduits after linearly connecting the portion of the plurality of elongated conduits, wherein a quantity of thermal energy is transferred from the thermal conductor to the at least one fluid-transporting pathway of each of the linearly connected elongated conduits.

15. The method of claim 14, further comprising the step of positioning a bundle jacket about each of the exterior of the plurality of elongated conduits and the at least one heat tracing structure, respectively, after positioning the thermal conductor through the at least one heat tracing structure bonded to each of the connected elongated conduits.

16. The method of claim 14, further comprising the step of transferring the quantity of thermal energy from the thermal conductor to each of the linearly connected elongated conduits using a heat transfer plate, wherein the heat transfer plate is bonded between the at least one heat tracing structure and each of the plurality of elongated conduits.

17. The method of claim 14, wherein positing a thermal conductor through the at least one heat tracing structure further comprising pumping a thermal fluid medium through the at least one heat tracing structure.

18. The method of claim 14, further comprising the steps of:
removing the thermal conductor from the at least one heat tracing structure without disconnecting the portion of the plurality of elongated conduits end to end and the at least one heat tracing structure for each of the elongated conduits end to end; and
positioning a new thermal conductor through the at least one heat tracing structure bonded to each of the connected elongated conduits.

19. The method of claim 14, wherein the at least one heat tracing structure partially insulates each of the plurality of elongated conduits from the quantity of thermal energy transferred from the thermal conductor.

20. A method of manufacturing a thermally-regulated fluid transport system, the method comprising the steps of:
providing a plurality of elongated conduits, each having at least one fluid-transporting pathway;
bonding at least one heat tracing structure to a surface of each of the elongated conduits;
linearly connecting at least a portion of the plurality of elongated conduits;
positioning a bundle jacket about the exterior of the portion of the elongated conduits having the at least one heat tracing structure bonded thereto; and
positioning a thermal conductor through the at least one heat tracing structure bonded to each of the connected elongated conduits after linearly connecting the portion of the plurality of elongated conduits.
